(19) United States
(12) Patent Application Publication
(10) Pub. No.: US 2025/0061347 A1
(43) Pub. Date: Feb. 20, 2025

(54) QUESTION ANSWERING SYSTEM WITH USER CONTEXT

(71) Applicant: International Business Machines Corporation, Armonk, NY (US)

(72) Inventors: Jun Su, Beijing (CN); YANG LIANG, BeiJing (CN); Su Liu, Austin, TX (US); James Nash, Lewisville, TX (US)

(21) Appl. No.: 18/451,394

(22) Filed: Aug. 17, 2023

(51) Int. Cl. G06N 5/02; G06N 5/04

(52) U.S. Cl. CPC G06N 5/02; G06N 5/04

(57) ABSTRACT

Providing individualized answers to questions including receiving a question input by a user, identifying a topic of the question and a user's reading level, mapping the topic to an answer generator and knowledge graph according to the user's reading level. Also including generating a response to the question according to the knowledge graph and providing the response to the user.

### FIELD OF THE INVENTION

The disclosure relates generally to automated question answering systems and methods. The invention relates particularly to automated question answering systems enhanced with individual user context.

### BACKGROUND

In the area of Human Computer Interactions, artificial intelligence (AI) based Chatbots or conversational robots are increasingly common. Such Chatbots may be used to provide “RIGHT” answers to user's questions. An AI-Chatbot can generate answers based on a model trained using a vast training database of information which may be used to train a generative model. A Chatbot uses machine learning algorithms, such as Natural Language Processing, to understand user questions and then generate accurate and helpful responses. An AI-Chatbot may use deep learning techniques to generate responses to natural language queries. AI-Chatbots have demonstrated impressive capabilities in tasks such as language translation, question answering, and text completion.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable automated question answering enhanced with individualized user context.

Aspects of the invention disclose methods, systems and computer readable media associated with providing individualized answers to questions including receiving a question input by a user, identifying a topic of the question and a user's reading level, mapping the topic to an answer generator and knowledge graph according to the user's reading level. Also including generating a response to the question according to the knowledge graph and providing the response to the user.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Chatbots typically lack any ability to personalize generated responses to match a user's knowledge level and/or emotional state. This may result in inaccurate or irrelevant responses, which in turn frustrate users and reduce engagement with, and subsequent use of, the chatbot.

In one embodiment, a chatbot adapts to the user's knowledge level and requests user context information during real-time interactions. A chatbot uses advanced Natural Language Processing (NLP) and Natural Language Understanding (NLU) to analyze the user's inputs and to generate individualized responses which match the needs and expectations of the user. In this embodiment, disclosed methods and systems collect and analyze real-time and historical data from user interactions to build customized knowledge graphs and to refine individual user profiles. This approach improves the accuracy and relevance of responses, enhances user engagement and satisfaction with the chatbot.

Disclosed systems and methods may improve customer satisfaction, leading to increased customer loyalty and repeat business by providing personalized responses that match the user's expectations and knowledge level. The use of advanced machine learning algorithms and data analysis techniques can help the chatbot generate responses quickly and accurately, reducing the need for human intervention. By automating customer service and support, businesses can save on labor costs and improve overall efficiency. The chatbot's ability to collect and analyze data from various sources can provide valuable insights into customer behavior and preferences, allowing businesses to make more informed decisions. The chatbot can be used to gather customer feedback and insights, which can be used to improve marketing strategies and product development. By providing personalized recommendations and support thereby increasing user engagement, the chatbot can help increase sales and revenue. A personalized chatbot can help improve the brand image of a business, showcasing its commitment to customer satisfaction and innovation. The chatbot can handle a large volume of customer interactions, allowing businesses to scale up their operations without compromising customer service quality. The use of a personalized chatbot can provide a competitive advantage for businesses, allowing them to differentiate themselves from competitors and improve customer retention.

As a non-limiting example of current chatbot limitations, when presented with a questions prompt of: “What is photosynthesis?” a chatbot has a high likelihood of providing the same answer regardless of the knowledge level of the user entering the prompt. Whether such a user possesses a science knowledge level typical of a fifth grade student early in the year, or that of a college biology professor, the chatbot provides a common answer. Such an answer may frustrate each exemplary user as it may be too complex for the student and too simplistic for he professor, thereby triggering a succession of additional prompts as each user attempts to refine the answer to meet their needs. Depending upon the user's success in making such refinements, the user may cease to engage with the chatbot, and may be discouraged from future uses of the chatbot. Disclosed embodiments adapt chatbot interactions to individual users through analysis of user-chatbot interactions, and application of the context extracted through that analysis.

Aspects of the present invention relate generally to question answering systems and, more particularly, to individualizing chatbot responses to a user's knowledge level for answering questions. In embodiments, a question answering (QA) system receives a question input by a user, the QA system identifies a topic of the question and a user's reading level, the system maps the topic to an answer generator and knowledge graph according to the user's reading level. The system then generates a response to the question according to the knowledge graph and provides the response to the user. In this manner, implementations of the invention learn and continually adjust individual knowledge graphs such that the QA system returns answers tailored to the individual knowledge levels of each user.

In accordance with aspects of the invention there is a method for automatically adjusting a context driven user knowledge level for a chatbot, the method c receives a question input by a user, the QA system identifies a topic of the question and a user's reading level, the system maps the topic to an answer generator and knowledge graph according to the user's reading level. The system then generates a response to the question according to the knowledge graph and provides the response to the user. In this manner, implementations of the invention learn and continually adjust individual knowledge graphs such that the QA system returns answers tailored to the individual knowledge levels of each user.

Aspects of the invention provide an improvement in the technical field of QA systems. Conventional QA systems utilize static (i.e., unchanging) user knowledge levels when generating an answer to a question posed by a user. In many cases, methods and systems do not differentiate between users in generating answers to queries. As a result, systems provide identical answers to diverse users. In some cases, however, users might provide useful context regarding their respective knowledge levels enabling the generation and provision of customized responses. Implementations of the invention leverage this knowledge/context by utilizing a mapper to determine the chatbot version best suited to generate a response to a user's question. This provides the improvement of matching the knowledge level of a generated response to the knowledge level of the user, thereby increasing user engagement and reducing user frustrations due to overly simplistic, or overly complicated, responses from a chatbot.

Aspects of the invention also provide an improvement to computer functionality. In particular, implementations of the invention are directed to a specific improvement to the way QA systems operate, embodied in the continually adjusted knowledge graphs for different user groups and individual users. In embodiments, the system adjusts the knowledge graphs for groups and individuals according to user feedback related to provided responses. As a result of adjusting the user's knowledge graph based on the feedback on responses, the system increases the likelihood that the system will provide a knowledge-level appropriate answer for the next question of the user, thereby maintaining user engagement with the system. In this manner, embodiments of the invention affect how the QA system functions (i.e., the likelihood of providing an appropriate answer to a question) from one question to the next.

As an overview, a QA system is an artificial intelligence application executed on data processing hardware that answers questions pertaining to a given subject-matter domain presented in natural language. The QA system receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA system. The document may include any file, text, article, or source of data for use in the QA system. For example, a QA system accesses a body of knowledge about the domain, or subject matter area (e.g., financial domain, medical domain, legal domain, etc.) where the body of knowledge (knowledgebase) can be organized in a variety of configurations, such as but not limited to a structured repository of domain-specific information, such as ontologies, or unstructured data related to the domain, or a collection of natural language documents about the domain.

In an embodiment, one or more components of the system can employ hardware and/or software to solve problems that are highly technical in nature (e.g., receiving a question input by a user, identifying a topic of the question and a user's reading level, mapping the topic to an answer generator and knowledge graph according to the user's reading level, generating a response to the question according to the knowledge graph, providing the response to the user, etc.). These solutions are not abstract and cannot be performed as a set of mental acts by a human due to the processing capabilities needed to facilitate tailored chatbot responses, for example. Further, some of the processes performed may be performed by a specialized computer for carrying out defined tasks related to individualized chatbot response generation. For example, a specialized computer can be employed to carry out tasks related to personalized QA system responses, or the like.

In one embodiment, methods define an answer generation framework for the QA system. The framework includes a data structure with related algorithms for storing/saving, tracking, analyzing, and using data received from human-computer interactions in a user-computer environment. Exemplary data may include Answer generation data, user ID, age, education level, topic list, question ID, user question, adaptation commands, customized answers, default answers, etc. Beyond data from monitored user interactions, system administrators and users may define and adjust user readability criteria for respective knowledge levels, and subject matter areas, math, language arts, social studies, science, etc., for use by the methods and systems.

In one embodiment, during a learning phase, systems and methods monitor the activities of users: (inputs/outputs, conversations, browsed webpages, asked questions, searching keywords), in a Human-Computer Interaction from various sources (social media, web pages, user feedback etc.). In this embodiment, systems and methods collect data for the data structure as key information from the monitored activities. Analysis of the collected data using the defined readability criteria dimensions enables the systems and methods to classify users according to a defined readability level. Systems and methods create/update knowledge graphs for each defined readability level and associate the knowledge graphs with users classified as members of the corresponding readability level. Individual user profiles may then be updated as to current user knowledge level and a personalized user knowledge graph may be updated and saved.

Knowledge graphs (KG) represent information in a structured format, where nodes represent entities and edges represent relationships between these entities. They can vary significantly based on an individual's knowledge and education level.

KG may be created/updated using an educational level, e.g., total vocabulary number, because it is a widely used comprehensive standard. The total vocabulary of individuals can vary significantly depending on their education level and exposure to different subjects. As an exemplary comparison of the total vocabularies for a 5th-grade student and a biological professor: 5th-Grade Student: The vocabulary of a typical 5th-grade student varies, but on average, they might have a vocabulary of around 6,000 to 8,000 words. By this age, children have built a foundational vocabulary through reading, classroom instruction, and daily interactions. However, their vocabulary is still developing, and they are continuously learning new words. Biological Professor: A biological professor, with their advanced education and expertise in the field, generally has a much larger and specialized vocabulary. It is challenging to quantify an exact number, but it is safe to assume that a biological professor's vocabulary can range from 50,000 to over 100,000 words or more. This extensive vocabulary includes scientific terminology, technical terms, and domain-specific jargon related to biology and their area of expertise.

By giving keyword of “photosynthesis”, methods build a knowledge graph based on the vocabulary. For a 5th grade student, all elements for root word “photosynthesis” shall be selected from 6,000 words. But for biological professor, all elements for root word “photosynthesis” shall be selected from 50,000 words. There are more dimensions and aspects for building KG. When comparing the knowledge graph of a 5th-grade student to that of a biological professor on the topic of “photosynthesis,” methods further consider notable differences: Depth of Understanding: The biological professor's knowledge graph tends to be more comprehensive and detailed than that of a 5th-grade student. The professor's graph might contain advanced scientific concepts, intricate biochemical processes, and the latest research findings related to photosynthesis. Terminology and Vocabulary: The language used in the professor's knowledge graph might involve scientific jargon, technical terms, and complex descriptions. In contrast, the 5th-grade student's knowledge graph would likely use simpler language and explanations suitable for their age and educational level. Breadth of Coverage: The biological professor's knowledge graph may encompass a broader range of sub-topics related to photosynthesis, including historical developments, ecological impacts, and various aspects of plant physiology. On the other hand, the 5th-grade student's knowledge graph might focus on the basic principles and general understanding of photosynthesis. Level of Detail: The knowledge graph of the biological professor may contain extensive details, equations, and illustrations related to the biochemical processes involved in photosynthesis. In contrast, the 5th-grade student's graph would provide a more foundational understanding without delving into advanced biochemical intricacies. Critical Analysis: The professor's knowledge graph may include critical analysis, evaluations of different theories, and references to contrasting research studies. Conversely, the 5th-grade student's graph may not include such in-depth analysis but rather focus on building a fundamental understanding of the concept.

Knowledge Graph for a 5th-Grade Student on Photosynthesis:
1. What is Photosynthesis?
   Process by which plants make food using sunlight, water, and air.
2. Photosynthesis Equation:
   Carbon Dioxide+Water+Sunlight→Glucose+Oxygen
3. Main Components:
   Sunlight: Provides energy for photosynthesis.
   Chlorophyll: Pigment that captures sunlight in plant cells.
   Carbon Dioxide: Absorbed from the air through tiny pores called stomata.
   Water: Absorbed from the soil through the roots.
   Glucose: Food produced by plants for energy.
   Oxygen: Released as a byproduct into the air.
4. Where Does Photosynthesis Occur?
   Mostly in the leaves of plants.
5. Why is Photosynthesis Important?
   Produces food for plants.
   Releases oxygen, which is essential for animals and humans.
6. Photosynthesis and the Food Chain:
   Plants are primary producers, and other animals depend on them for food.
7. Fun Fact:
   Photosynthesis is why plants are green! Chlorophyll reflects green light.

Exemplary Knowledge Graph for a Biological Professor on Photosynthesis:
1. Photosynthesis Overview:
   An intricate process by which autotrophic organisms convert light energy into chemical energy.
2. Photosynthetic Reactions:
   Light-dependent reactions occur in thylakoid membranes.
   Photosystem I and II: Complexes that capture and transfer light energy.
   Electron Transport Chain: Facilitates electron movement and ATP synthesis.
   Light-independent reactions (Calvin Cycle) occur in the stroma.
   Carbon Fixation: CO2 combined with RuBP to form 3PGA.
   Reduction and Regeneration: 3PGA converted into G3P and regenerated RuBP.
3. Photosynthetic Pigments:
   Chlorophylls: Chlorophyll a and b absorb light in the red and blue-violet regions.
   Carotenoids: Absorb excess light and protect against photooxidation.
4. Factors Affecting Photosynthesis:
   Light intensity, wavelength, and duration.
   Temperature and CO2 concentration.
   Water availability and nutrient levels.
5. Photosynthesis in Different Organisms:
   C3, C4, and CAM pathways in plants with different CO2 fixation strategies.
6. Photosynthesis and Global Carbon Cycle:
   Crucial role in sequestering carbon dioxide and balancing atmospheric gases.
7. Photosynthesis and Environmental Factors:
   Responses to environmental stressors, like drought or pollution.
8. Photosynthesis Research and Innovations:
   Current advancements in understanding photosynthesis mechanisms.
   Biotechnological applications for crop improvement and renewable energy.
9. Historical Perspectives:
   Contributions of early scientists to photosynthesis research.

In one embodiment, readability level factors include vocabulary-including jargon and technical language usage, sentence length, paragraph length, and writing style including the use of humor, metaphors, and other literary devices.

In one embodiment, during run-time, or in real-time service, systems and methods receive questions inputted by users through the human-computer interactions. Using Natural Language Processing (NLP) and Natural Language Understanding, (NLU), systems and methods analyze the questions to identify one or more question topics and to determine a readability level for each user submitting questions. In one embodiment, the method compares the determined readability level for a user with the level stored in the profile for the user. The method updates the user's profile as needed to match the latest readability determination for the user. The method maps the identified topic information to an appropriate answer generation module according to the determined readability level. In one embodiment, the method and system include separate answer generation modules and generalized knowledge graphs for each defined readability level. After mapping, the appropriate answer generation module generates an answer which is on topic, has the appropriate readability level and includes the knowledge level indicated by the corresponding knowledge graph. After generation, the method provides the generated answer to the human computer interface where the answer is rendered in a manner suitable to the user. In one embodiment, the user profile includes one or more setting relating to the preferences of the user for receiving the generated answers.

The methods evaluate the inputted user questions utilizing natural language processing (NLP), or natural language understanding (NLU). Disclosed embodiments can perform natural language processing for extraction of NLP output parameter values from provided inputs of a user. NLP includes performing one or more of a topic classification process that determines topics of documents, one or more topic NLP output parameter values, a sentiment analysis process which determines sentiment parameter value for documents and document portions, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameter values, e.g., one of more “social tendency” NLP output parameter or one or more “writing style” NLP output parameter, and/or one or more part of speech NLP output parameter value. Part-of-speech tagging methodologies can include the use of, e.g., Constraint Grammar, Brill tagger, Baum-Welch algorithm (the forward-backward algorithm), and the Viterbi algorithm which can employ the use of the Hidden Markov models. Hidden Markov models can be implemented using the Viterbi algorithm. The Brill tagger can learn a set of rule patterns and can apply those patterns rather than optimize a statistical quantity. Applying natural language processing can also include performing sentence segmentation which can include determining where a sentence ends, including, e.g., searching for periods, while accounting for periods that designate abbreviations.

After providing the generated answer(s), systems and method receive and analyze user feedback related to the answer, “too simplistic”, “too complicated”, etc., and adjust the knowledge graphs for the user according to the feedback. In one embodiment, methods further associate the feedback from users with the general readability level classification for the user and modify the general knowledge graph for the readability classification level according to the feedback.

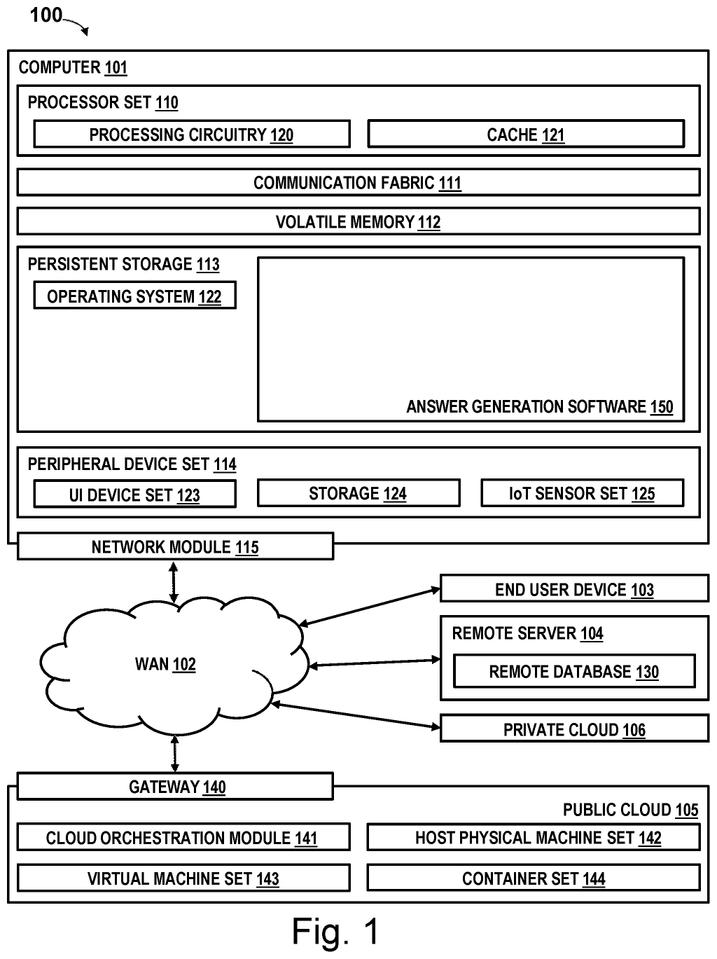

As shown in FIG. 1, computing environment 100 contains an example of an environment for the execution of at least some of the computer code involved in performing the inventive methods, such as individualized chatbot answer generation method software 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

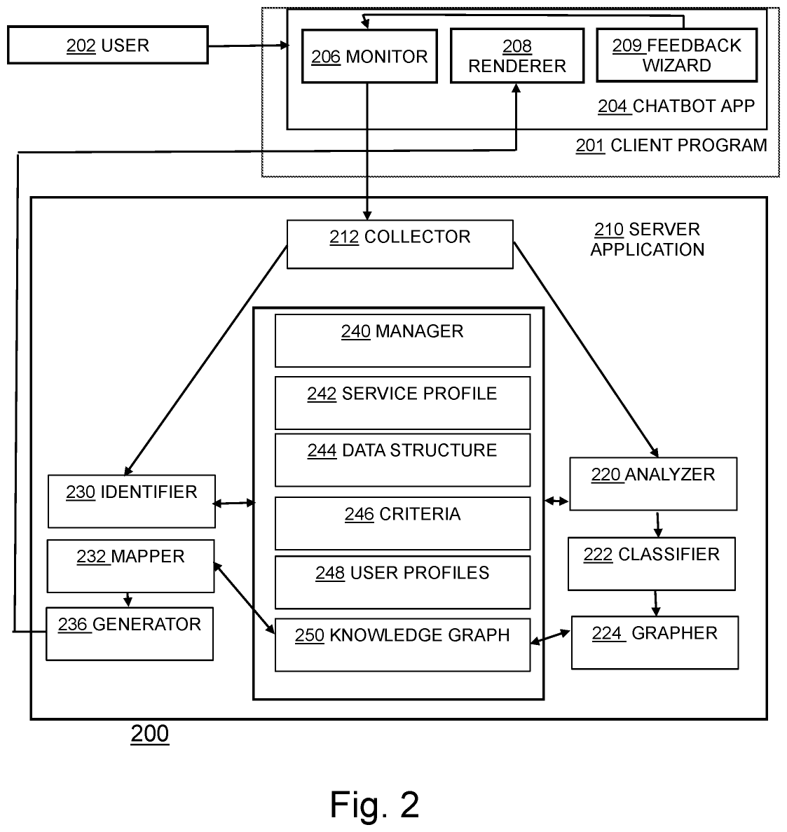

FIG. 2 provides a flowchart 200, illustrating exemplary activities associated with the practice of the disclosure. After program start, a user 202, interacts with a QA system, or Chatbot Application 204 of client program 201. Client program 201 includes modules providing the capabilities of monitoring user interactions, sending data from monitored activities to a server application, receiving responses from the server application, rendering the responses for the user, receiving user feedback regarding the responses, and sending the user feedback to the server application 210. Server application 210 analyzes user interaction data, determines a user's knowledge and readability level, adapts a Chatbot to the knowledge and readability levels of the user, and provides answers generated by the Chatbot. Server program 210 also receives user feedback regarding the provided answers, analyzes the feedback and alters the user profiles and knowledge graphs according to the analysis.

In one embodiment, server application 210 includes a manager 240, which provides a user interface allowing administrators and users to configure and mange system services, create/edit personalized user settings and user profiles 248, define readability level criteria 246, adjust system algorithms, including NLP/NLU algorithms, adjust the defined data structures 244 described above, and store these elements in system service profiles 242.

Monitor 206 monitors user activities (inputs/outputs, conversations, browsed webpages, asked questions, searching keywords) in a Human-Computer Interaction from various sources (social media, web pages, user feedback etc.), and passes this data to Collector 222 of Server application 210. Collector 222 passes data to Identifier 230 which in turn utilizes NLP/NLU to analyze user input and extract question topics and discern a user readability level. Identifier 230 passes the topics and readability level from the analysis to the QA answer generator server program mapper 232. Identifier 230 also passes topic, readability level, and other data from the monitor to other elements of the server program 210, including manager 240.

Mapper 232 maps the topic and readability data to the corresponding response generator module and associated knowledge graph for the user and the generalized knowledge graph for the readability level, according to the readability level.

Generator 236 receives the corresponding generator module and knowledge graphs and generates a response for the input question. The method passes the generated question from generator 236 to renderer 208 of the client program 201. Renderer 208 presents the generated answer to user 202 utilizing the display settings stored in the user's profile 248.

After viewing the generated answer, user 202 may provide feedback regarding the answer through the feedback wizard 209, which receives the feedback and passes it to the monitor 206, collector 212, then to analyzer 220, which analyzes the feedback and determines updates needed for the relevant user profile, user knowledge graph, and group knowledge graph. Results of the analysis may be passed to the manager 240, service profile 242, data structure 244, criteria 246, user profiles 248, and stored category and user knowledge graphs 250, as described above. Feedback may also be passed to classifier 222, which classifies users into defined groups according to NLP/NLU analysis of the feedback and the use of a classification algorithm such as a clustering algorithm. Feedback is then used to update relevant knowledge graphs at knowledge grapher 224.

### Examples

In one embodiment, methods and systems may adapt a prompt to a chatbot to include the use of a personalized KG for a 5th grade student, such as the KG set forth above: Adapt to 5th Grade Student Expectation: A simple explanation that 5th grade student can understand for Elementary School Project Report. Alternatively, systems and methods may adapt the prompt for the chatbot according to a KG for a Professor, as set forth above, Adapt to Biological Professor Expectation: A detailed explanation with the chemical reactions involved and the role of pigments, enzymes, and electron transport chain for Biological Research and Education.

It is to be understood that although this disclosure includes a description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, or media, as those terms are used in the present disclosure, explicitly excludes storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage medium or device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for providing individualized answers to questions, the method comprising:
receiving, by one or more processors, a question input by a user;
identifying, by the one or more processors, a topic of the question and a user's reading level;
mapping, by the one or more processors, the topic to an answer generator and knowledge graph according to the user's reading level;
generating, by the answer generator of the one or more processors, a response to the question according to the knowledge graph; and
providing, by the one or more processors, the response to the user.

2. The computer implemented method according to claim 1, further comprising:
receiving, by the one or more processors, feedback regarding the response, from the user; and
altering, by the one or more processors, the knowledge graph according to the feedback.

3. The computer implemented method according to claim 1, further comprising:
monitoring, by the one or more processors, computer interactions of the user:
collecting data, by the one or more processors, from the monitored computer interactions;
analyzing, by the one or more processors, the collected data according to defined dimensions;
classifying, by the one or more processors, the user according to the analysis of the collected data;
updating, by the one or more processors, a user profile according to the classification; and
updating, by the one or more processors, a knowledge graph according to the classification.

4. The computer implemented method according to claim 1, further comprising:
receiving, by the one or more processors, input regarding a service profile; and updating, by the one or more processors, the service profile according to the input.

5. The computer implemented method according to claim 1, further comprising:
receiving, by the one or more processors, input regarding a user profile; and updating, by the one or more processors, the user profile according to the input.

6. The computer implemented method according to claim 1, further comprising:
receiving, by the one or more processors, input regarding a classification criteria: and
updating, by the one or more processors, the classification criteria according to the input.

7. The computer implemented method according to claim 1, further comprising defining, by the one or more processors, a data structure including relevant user data.

8. A computer program product for providing individualized answers, the computer program product comprising one or more computer readable storage media and collectively stored program instructions on the one or more computer readable storage media, the stored program instructions which, when executed, cause one or more computer systems to:
receiving, by one or more processors, a question input by a user;
identifying, by the one or more processors, a topic of the question and a user's reading level;
mapping, by the one or more processors, the topic to an answer generator and knowledge graph according to the user's reading level;
generating, by the answer generator of the one or more processors, a response to the question according to the knowledge graph; and
providing, by the one or more processors, the response to the user.

9. The computer program product according to claim 8, the computer program instructions further causing the one or more processors to:
receive feedback regarding the response, from the user; and
alter the knowledge graph according to the feedback.

10. The computer program product according to claim 8, the computer program instructions further causing the one or more processors to:
monitor computer interactions of the user:
collect data from the monitored computer interactions;
analyze the collected data according to defined dimensions;
classify the user according to the analysis of the collected data;
update a user profile according to the classification; and
update a knowledge graph according to the classification.

11. The computer program product according to claim 8, the computer program instructions further causing the one or more processors to:
receive input regarding a service profile; and
update the service profile according to the input.

12. The computer program product according to claim 8, the computer program instructions further causing the one or more processors to:
receive input regarding a user profile; and
update the user profile according to the input.

13. The computer program product according to claim 8, the computer program instructions further causing the one or more processors to:
receive input regarding a classification criteria; and
update the classification criteria according to the input.

14. The computer program product according to claim 8, the computer program instructions further causing the one or more processors to: define a data structure including relevant user data.

15. A computer system for providing, the computer system comprising:
one or more computer processors;
one or more computer readable storage media; and
stored program instructions on the one or more computer readable storage media for execution by the one or more computer processors, the stored program instructions which, when executed, cause the one or more computer processors to:
receiving, by one or more processors, a question input by a user;
identifying, by the one or more processors, a topic of the question and a user's reading level;
mapping, by the one or more processors, the topic to an answer generator and knowledge graph according to the user's reading level;
generating, by the answer generator of the one or more processors, a response to the question according to the knowledge graph; and
providing, by the one or more processors, the response to the user.

16. The computer system according to claim 15, the computer program instructions further causing the one or more processors to:
receive feedback regarding the response, from the user; and
alter the knowledge graph according to the feedback.

17. The computer system according to claim 15, the computer program instructions further causing the one or more processors to:
monitor computer interactions of the user:
collect data from the monitored computer interactions;
analyze the collected data according to defined dimensions;
classify the user according to the analysis of the collected data;
update a user profile according to the classification; and
update a knowledge graph according to the classification.

18. The computer system according to claim 15, the computer program instructions further causing the one or more processors to:
receive input regarding a service profile; and
update the service profile according to the input.

19. The computer system according to claim 15, the computer program instructions further causing the one or more processors to:
receive input regarding a user profile; and
update the user profile according to the input.

20. The computer system according to claim 15, the computer program instructions further causing the one or more processors to:
receive input regarding a classification criteria; and
update the classification criteria according to the input.
